(19) United States
(12) Patent Application Publication
(10) Pub. No.: US 2009/0213035 A1
(43) Pub. Date: Aug. 27, 2009

(54) Notebook Computer System with Dual Integrated Displays and Method

(75) Inventors: David Gray Edwards, Wake Forest, NC (US); Brian Woodall Killebrew, Raleigh, NC (US)

Correspondence Address: Lieberman & Brandsdorfer, LLC, 802 Still Creek Lane, Gaithersburg, MD, 20878, US

(73) Assignee: LENOVO (SINGAPORE) PTE. LTD., Singapore (SG)

(21) Appl. No.: 12/036,850

(22) Filed: Feb. 25, 2008

(51) Int. Cl. G09G 5/00

(52) U.S. Cl. 345/1.3

(57) ABSTRACT

A second display is integrated into a notebook computer system. The second display is mounted with the primary display and arranged for movement to various working positions which facilitate use with a second viewer or with programs which spread displays over two displays for clarity or working jointly with two programs such as a graphics program and a word processing program.

### FIELD AND BACKGROUND OF INVENTION

This invention relates to personal computer systems and particularly to a notebook system having two displays.

Users of notebook computer systems have discovered that when they use their systems in making presentations, there is oftentimes a difficulty in displaying a presentation to a small audience. With a large audience, a projector is useful. With a small audience, perhaps just one additional person, allowing visibility to what is displayed can be difficult.

Additionally, it is often useful in working on larger projects, either spreadsheets or documents accompanied by drawings, to distribute a display across two separate areas. Programs are available which will distribute displays over several screens. However, the displays of notebook systems are not well adapted to such multiple windows on a single display as characters become so small as to be difficult to read.

Adding an additional free standing display, such as those used with desktop computer systems, offers one solution. However, this solution imposes a significant burden on possible portability, one of the advantages of a notebook system.

### SUMMARY OF THE INVENTION

The present invention overcomes these deficiences of the prior art by integrating a second display into a notebook computer system. In accordance with this invention, a second display is mounted with the primary display and is arranged for movement to various working positions which facilitate use with a second viewer or with programs which spread displays over two displays for clarity or working jointly with two programs such as a graphics program and a word processing program.

More particularly, the present invention provides a second display which is coupled through an articulated hinge mechanism to accomplish movement among a stowed position and varioius working positions described more fully hereinafter.

### BRIEF DESCRIPTION OF DRAWINGS

Some of the purposes of the invention having been stated, others will appear as the description proceeds, when taken in connection with the accompanying drawings, in which:

FIG. 1 is a perspective view of a notebook system in accordance with the present invention with the second display in a stowed position;

FIG. 2 is a view similar to FIG. 1 of a first embodiment of the system of FIG. 1 with the second display moving from the stowed position toward a first working position;

FIG. 3 is a view similar to FIGS. 1 and 2 of the first embodiment of a notebook system in accordance with this invention with the second display in the first working position;

FIG. 4 is a view of the first embodiment with the second display moving toward a second working position;

FIG. 5 is a view similar to FIG. 4 of a second embodiment of the system of FIG. 1 with the second display moving from the stowed position toward a first working position;

FIG. 6 is a view similar to FIG. 3 of the system of FIG. 5 with the second display in the first working position;

FIG. 7 is a view of the system of FIGS. 5 and 6 with the second display moving from the first working position toward a second working position;

FIG. 8 is a view of the system of FIGS. 5 through 7 with the second display in the second working position; and

FIGS. 9 and 10 are two views of a hinge assembly useful in effectuating the arrangements of FIG. 1 through 8.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

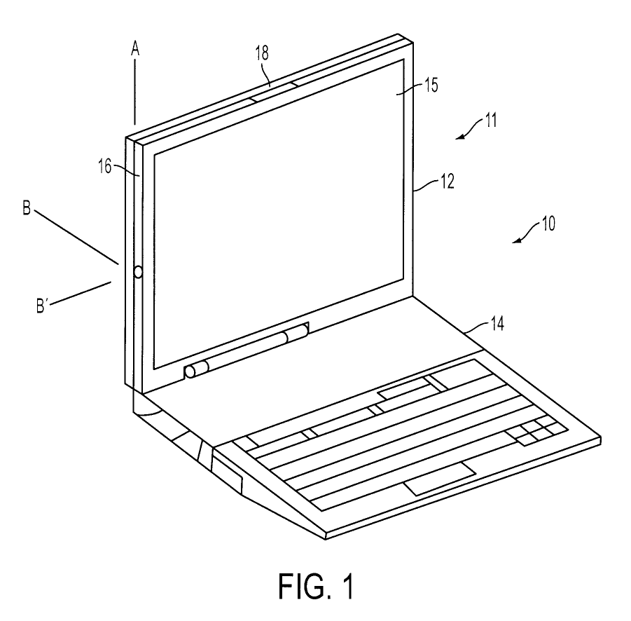

Referring now to FIG. 1, a notebook system in accordance with this invention, indicated generally at 10, has many characteristics in common with generally known systems of the type. These features include a clamshell housing 11 having hinged together upper and lower bodies 12, 14. Data handling system components including a keyboard are housed in one of the bodies, usually the lower body 14. A display 15, here called a primary or first display for reasons which will become more clear as the discussion proceeds, is housed in the other body 12 and so disposed that the display 15 and keyboard face one another as the housing 11 is closed. As described to this point, the notebook system is substantially conventional.

In accordance with distinct characteristics of the system of this invention, a hinge structure 16 is mounted on an edge of the other or upper body 12 and the primary display. The hinge structure 16 defines orthogonal axes indicated at A and B, B′ for rotation. That is, the axes defined by the hinge structure extend at a right angle or ninety degrees or perpendicularly from one another. The edge on which the hinge structure is mounted may be a side edge (as illustrated) or the upper edge (not illustrated). In the illustrated, side edge, embodiment of the present invention, one of the orthogonal axes is perpendicular to, generally intersects or nearly intersects and defines with the axis of the hinged connection of the upper and lower bodies a plane parallel to the primary display while the other extends perpendicularly to, and non-intersecting with, the axis of the hinged connection of the upper and lower bodies. In the alternate, upper edge, embodiment, one of the orthogonal axes is generally parallel to, spaced from and defines with the axis of the hinged connection of the upper and lower bodies a plane parallel to the primary display while the other is perpendicular to and non-intersecting with the axis of the hinged connection of the upper and lower bodies.

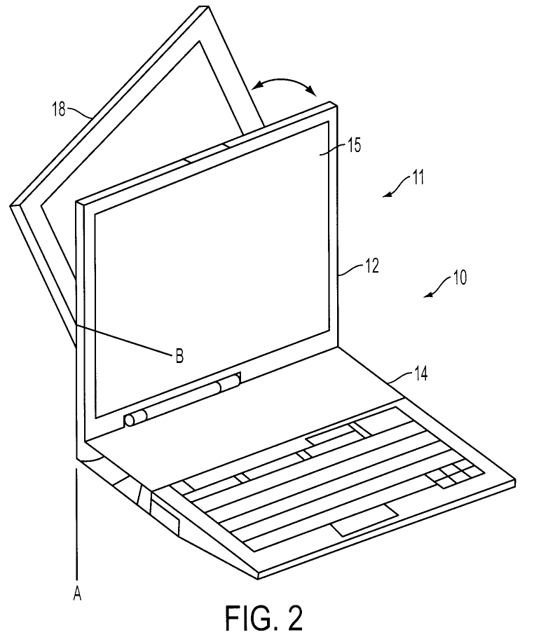

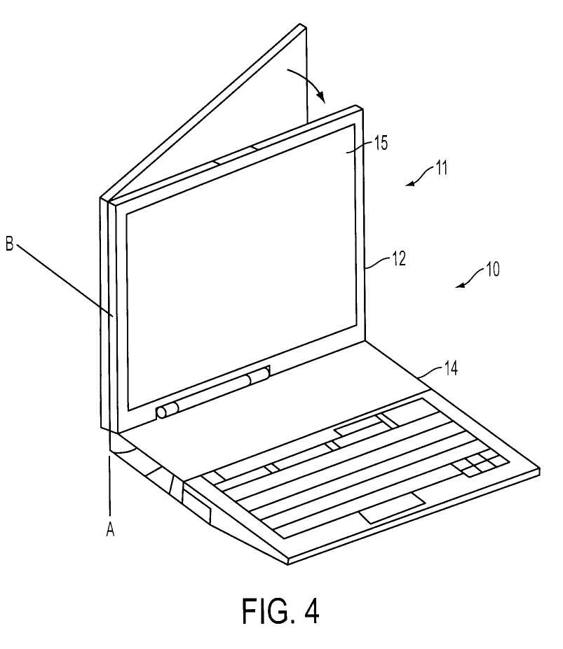

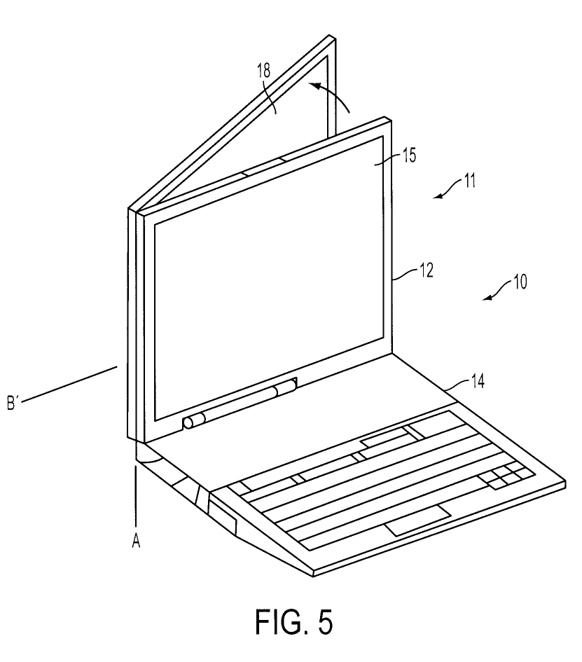

It is important to note that two axes B, B′ are shown in FIG. 1. These two axes distinguish two different embodiments of the present invention as will be described hereinafter. In one embodiment (to be described with reference to FIG. 2 through 4), the axis B extends perpendicularly to the plane of the primary or first display 15. In a second embodiment illustrated here (to be described with reference to FIG. 5 through 8), the axis B′ extends parallel to and spaced from the axis of the hinged connection of the upper and lower bodies. The reader should notice that the difference between FIGS. 4 and 5 is perhaps subtle and pay particular attention to the directions of the axes B and B′, as it is the location and direction of those axes which distinguishes the two embodiments here particularly illustrated. The reader should also be aware that embodiments are contemplated and described which are not specifically illustrated and yet are within the scope of this invention.

In further characterization of this invention, a secondary display 18 is coupled to the hinge structure 16 and to the other or upper body for pivotal movement about the orthogonal axes between a stowed position folded against the primary display (FIG. 1) and various working positions described herein. First and second working positions face the secondary display either in the same direction for viewing as the primary display or in the opposite direction for viewing. Positioned for viewing from the same direction as the primary display, the secondary display may be used either to make an additional screen available for a second viewer or to make available to a single viewer a display spread across two screens or a display driven by one program on one screen and a display driven by another program on the other. The hinge structure 16 contemplated by the present invention enables disposition of the secondary display either in a lateral alignment with the primary display or at an angle thereto to facilitate viewing by one or two users.

Consistent with this usage, the data handling system components housed within the bodies are coupled to the primary and secondary displays to supply data driving displays thereon, with the components selectively driving the same or differing displays to both of said primary and secondary displays.

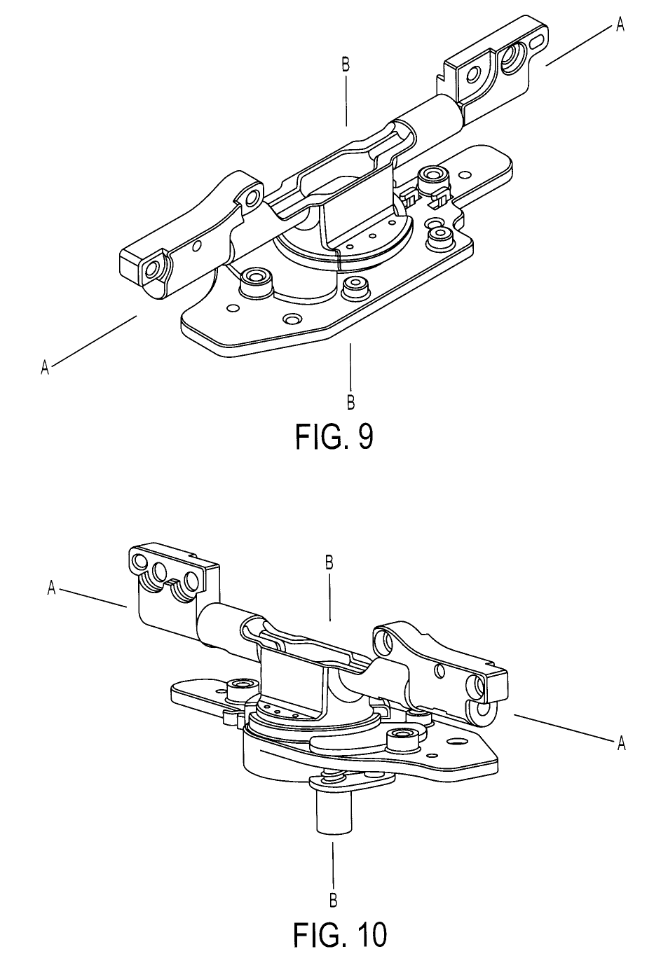

Returning to the hinge structure 16 (certain exemplary possible structure for which is shown in FIGS. 9 and 10, derived from the teachings of Liu et al U.S. Pat. No. 7,159,279), there are at least two manners in which the structure may be implemented. Defining those arrangements with reference to the axes about which the second display may move and as described above, the axis about which the two bodies of the clamshell housing move, and the body of the primary or first display, it may be noted that, in at least certain embodiments, one of said orthogonal axes (A in FIGS. 1 through 4) is parallel to a side edge of the primary display. This may be a lateral side edge adjacent to the hinged connection of the upper and lower clamshell bodies as shown or an upper or top side edge, remote from the hinged connection of the upper and lower clamshell bodies as described above. One of the orthogonal axes (B in FIGS. 1 through 4) may be perpendicular to the plane of the primary display. This arrangement is here described as the first of two illustrated embodiments.

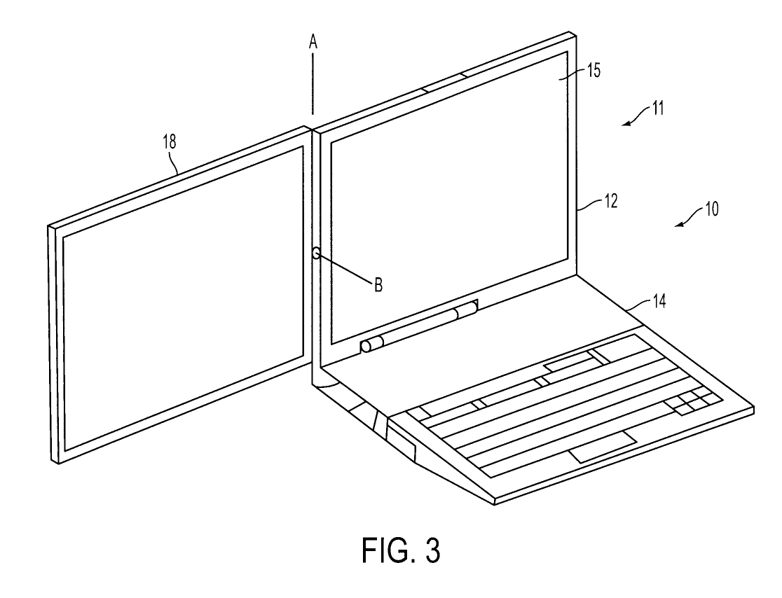

FIGS. 1 through 4 illustrate certain of these variations in the arrangement contemplated by the present invention. More particularly, what is shown is an arrangement in which the greatest flexibility is achievable and is a preferred embodiment. There, one of the orthogonal axes, A, lies along a lateral side edge of the primary display, here shown as the left side edge seen from a users position. The other orthogonal axis, B, extends perpendicularly to the first at a midpoint of the lateral side edge and enables rotation of the second display about the axis B between a stowed position (FIG. 1) and a first working position facing generally in the same direction for viewing as the primary display. Such motion is indicated in FIG. 2 and the first working position is shown in FIG. 3. Further, the hinge structure enables movement of the second display about the axis A toward a second working position folded back against the primary display, as indicated in FIG. 4.

This hinge construction also opens yet further possibilities. The second display comprises a secondary display housing providing a rigid protective backing for the secondary display. The articulation of the primary and secondary displays permitted by the hinge construction is such that the secondary display housing may be disposed externally of the apparatus when the secondary display is in the stowed position folded against the outside of the primary display, as in FIG. 1. That is, the articulation of the primary and secondary displays is such that the display screen of the secondary display, by rotation about the axis A may be disposed externally of the apparatus when the secondary display housing is otherwise in the stowed position. This is the position toward which the second display is moving in FIG. 4. Recognizing this characteristic, the secondary display may be a touchscreen enabled display, in which event the stowed position defines a third working position with the touchscreen accessible to a system user.

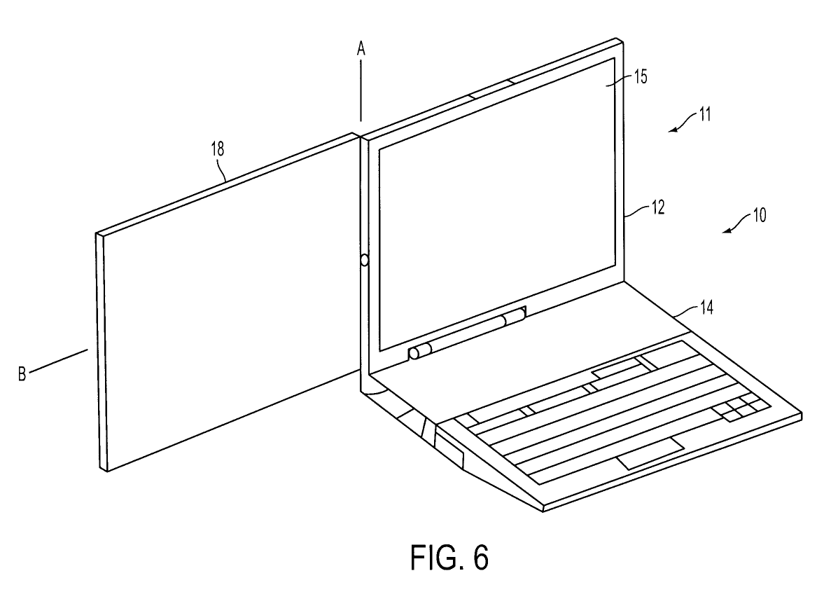

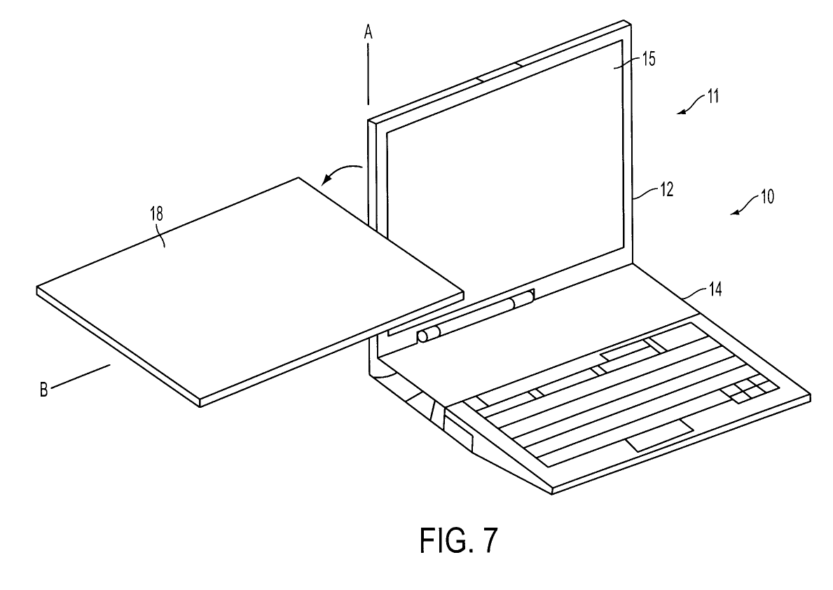

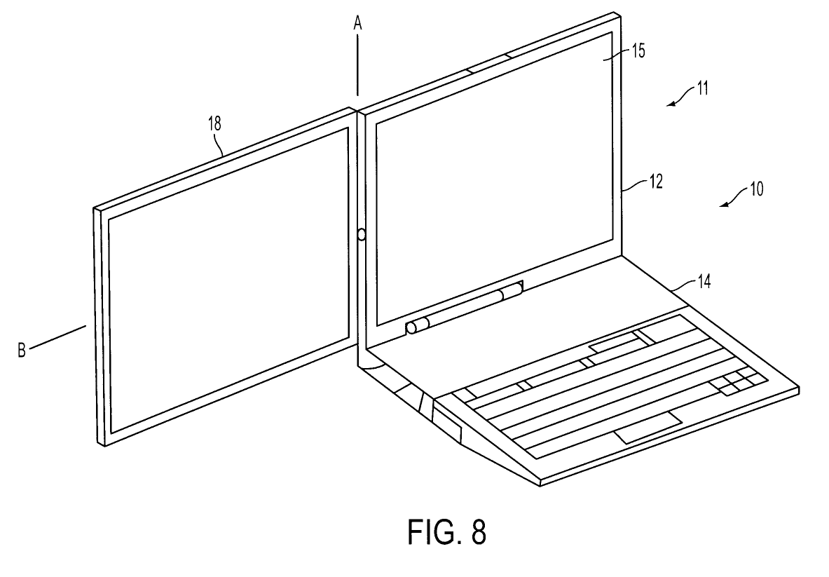

Turning now to FIGS. 5 through 8, an embodiment is there shown in which the two orthogonal axes are A and B′ of FIG. 1. FIG. 5 shows the second display moving from the stowed position by rotation about the axis A to a first working position shown in FIG. 6, where the secondary display faces oppositely to the primary display. As suggested above, the reader should take notice of the difference between FIGS. 4 and 5 related to the direction of the axes B and B′. In this embodiment, movement to the second working position is achieved by rotation about the axis B′, indicated in FIG. 7. That position is as shown in FIG. 8. Comparison of FIGS. 4 and 8 will make clear that working positions can provide a similar result even though achieved by a different utilization of the hinge structure.

As will be understood, the method of creating and using the apparatus described to this point comprises mounting a secondary display on a side edge of the primary display of a notebook computer system with a hinge structure which defines orthogonal axes for pivotal movement; and then selectively moving the secondary display about the orthogonal axes among a stowed position and first and second working positions. As here described, the stowed position disposes the second display against the exterior surface of the primary display. The first working position disposes the second display to one side of the primary display and facing in the same direction for viewing; and the second working position disposes the second display to one side of the primary display and facing in the opposite direction for viewing. The second display may be provided with touch screen capability and movement of the second display to the stowed position may dispose the touch screen surface of the second display for viewing and touch access.

In the drawings and specifications there has been set forth preferred embodiments of the invention and, although specific terms are used, the description thus given uses terminology in a generic and descriptive sense only and not for purposes of limitation.

What is claimed is:

1. Apparatus comprising:
a clamshell housing having hinged together upper and lower bodies;
a keyboard housed in one of said bodies;
a primary display housed in the other of said bodies and so disposed that said keyboard and said primary display face one another as said housing is closed; and
a secondary display coupled to said other body for pivotal movement about orthogonal axes between a stowed position folded against said primary display and first and second working positions unfolded from said primary display;
one of said first and second working positions orienting said secondary display to face oppositely from said primary display and the other of said working positions orienting said secondary display to face in the same direction as said primary display.

2. Apparatus according to claim 1 wherein one of said orthogonal axes is parallel to a side edge of said primary display.

3. Apparatus according to claim 1 wherein one of said orthogonal axes is perpendicular to a side edge of said primary display.

4. Apparatus according to claim 1 wherein one of said orthogonal axes is parallel to the axis of the hinge about which said bodies are hinged together.

5. Apparatus according to claim 1 wherein a plane defined by one of said orthogonal axes and the axis of the hinge about which said bodies are hinged together passes through said primary display.

6. Apparatus according to claim 1 wherein said secondary display comprises a secondary display housing providing a rigid protective backing for said secondary display and further wherein the articulation of said primary and secondary displays is such that the secondary display housing is disposed externally of the apparatus when said secondary display is in the stowed position.

7. Apparatus according to claim 1 wherein said secondary display comprises a display screen and a secondary display housing providing a rigid protective backing for said secondary display and further wherein the articulation of said primary and secondary displays is such that said display screen of said secondary display is disposed externally of the apparatus when said secondary display is in the stowed position.

8. Apparatus according to claim 7 wherein said secondary display is a touchscreen enabled display and further wherein the stowed position defines a third working position.

9. Apparatus according to claim 1 further comprising data handling system components housed within said one of said bodies and coupled to said primary and secondary displays to supply data driving displays thereon, said components driving the same display to both of said primary and secondary displays.

10. Apparatus according to claim 1 further comprising data handling system components housed within said one of said bodies and coupled to said primary and secondary displays to supply data driving displays thereon, said components driving differing displays to each of said primary and secondary displays.

11. Apparatus comprising:
a clamshell housing having hinged together upper and lower bodies;
data handling system components including a keyboard housed in said lower body;
a primary display housed in said upper body and so disposed that said keyboard and said primary display face one another as said housing is closed;
a hinge structure mounted on a lateral side edge of said primary display and defining orthogonal axes for rotation, one of said orthogonal axes defining with the axis of the hinged connection of said upper and lower bodies a plane parallel to said primary display;
a secondary display coupled to said hinge structure and said upper body for pivotal movement about said orthogonal axes between a stowed position folded against said primary display and first and second working positions unfolded from said primary display;
one of said first and second working positions orienting said secondary display to face oppositely from said primary display and the other of said working positions orienting said secondary display to face in the same direction as said primary display.

12. Apparatus comprising:
a clamshell housing having hinged together upper and lower bodies;
data handling system components including a keyboard housed in said lower body;
a primary display housed in said upper body and so disposed that said keyboard and said primary display face one another as said housing is closed;
a hinge structure mounted on a lateral side edge of said primary display and defining orthogonal axes for rotation, each of said orthogonal axes defining with the axis of the hinged connection of said upper and lower bodies a plane parallel to said primary display;
a secondary display coupled to said hinge structure and said upper body for pivotal movement about said orthogonal axes between a stowed position folded against said primary display and first and second working positions unfolded from said primary display;
one of said first and second working positions orienting said secondary display to face oppositely from said primary display and the other of said working positions orienting said secondary display to face in the same direction as said primary display.

13. Method comprising;
structuring a hinge to define orthogonal axes for rotation; and
mounting a secondary display on a side edge of a primary display of a notebook computer system with the hinge structure for pivotal movement of the secondary display among a stowed position and first and second working positions;
the stowed position disposing the second display against the exterior surface of the primary display;
the first working position disposing the second display to one side of the primary display and facing in the same direction for viewing; and
the second working position disposing the second display facing in the opposite direction of the primary display for viewing.

14. Method according to claim 13 wherein the second display is provided with touch screen capability and further wherein the second display when in the stowed position disposes the touch screen surface of the second display for viewing and touch access.
